(19) United States
(12) Patent Application Publication
(10) Pub. No.: US 2026/0042111 A1
(43) Pub. Date: Feb. 12, 2026

(54) ALL-PLASTIC LOTION PUMP

(71) Applicant: HCP PACKAGING (SHANGHAI) CO., LTD., Shanghai (CN)

(72) Inventor: Yue Ma, Shanghai (CN)

(73) Assignee: HCP PACKAGING (SHANGHAI) CO., LTD., Shanghai (CN)

(21) Appl. No.: 18/998,312

(22) PCT Filed: Jun. 29, 2023
(86) PCT No.: PCT/CN2023/103661

§ 371 Date: Jan. 24, 2025

(30) Foreign Application Priority Data
Jul. 26, 2022 (CN) 202221943530.6

(51) Int. Cl. B05B 11/10; A47K 5/12

(52) U.S. Cl. CPC B05B 11/1077; A47K 5/1205

(57) ABSTRACT

Disclosed is an all-plastic lotion pump, comprising a container cap and a pump core assembly provided on the container cap. The pump core assembly at least comprises a connecting rod capable of moving up and down relative to the axial direction of the container cap, an actuator fixedly provided at the top of the connecting rod, a pump body fixedly provided on the container cap in a matching manner, and a matching member fixedly provided on the pump body in a matching manner. The lotion pump further comprises an elastic member for providing an action force required for the connecting rod and the actuator to move upwards to be away from the container cap. The elastic member and one of the actuator, the connecting rod, the matching member, and the container cap are integrally provided.

### CROSS REFERENCE TO RELATED APPLICATIONS

The present application is the U.S. National Phase of PCT/CN2023/103661 filed Jun. 29, 2023, which claims priority to Chinese Patent Application No. 202221943530.6, entitled “All-plastic Lotion Pump”, filed with China National Intellectual Property Administration on Jul. 26, 2022, the entire contents of which is incorporated herein by reference.

### TECHNICAL FIELD

The disclosure relates to the field of cosmetic packaging, and in particular, to an all-plastic lotion pump.

### BACKGROUND

Packaging containers, such as lotion pumps and vacuum pumps, are widely used for packaging cosmetics to bring convenience to daily life of people, and mainly used to pump lotions out of daily cleaning and skin care products, such as hand sanitizers, shower gels, shampoos, facial cleansers, and moisturizing lotions. The packaging container has various structural forms, and basically includes a head cap connecting rod and a spring, the lotion is required to be pumped out by pressing the head cap connecting rod downwards, and the head cap connecting rod can be reset under the action force of the spring after the head cap connecting rod is released. However, since the spring is usually a metal member, the spring is required to be detached and separated separately after the cosmetic is used up, resulting in a high recycling cost.

In order to solve the above problem, Chinese patent CN216003683U discloses an all-plastic pump for cosmetics and a cosmetic container, in which an elastic member integrally made of a plastic material is adopted to replace the metal spring in the prior art, so that the cosmetic container can be recycled integrally; however, the arrangement of the elastic member requires addition of a mold to increase the production cost, and meanwhile, mounting thereof is inconvenient.

### SUMMARY

An object of the disclosure is to provide an improved all-plastic lotion pump to solve one or more of the problems of the prior art.

In order to achieve the above object, a technical solution employed by the present disclosure is: an all-plastic lotion pump includes a container cap and a pump core assembly provided on the container cap, wherein the pump core assembly at least includes a connecting rod capable of moving up and down relative to an axial direction of the container cap, an actuator fixedly provided at a top of the connecting rod, a pump body fixedly provided on the container cap in a matching manner, and a matching member fixedly provided on the pump body in a matching manner, the lotion pump further includes an elastic member for providing an action force required for the connecting rod and the actuator to move upwards to be away from the container cap, the elastic member and one of the actuator, the connecting rod, the matching member, and the container cap are integrally provided, the elastic member at least includes a first ring portion capable of sleeving a periphery of an outer side of the connecting rod in a sliding fit manner and a body portion capable of elastically stretching in an up-down direction, the body portion includes more than one elastic strip, all the elastic strips extend spirally with an axis of the connecting rod as a rotation center line, one end portion of the body portion is fixedly connected with the first ring portion, and the other end portion of the body portion is connected with one of the actuator, the connecting rod, the matching member, and the container cap.

In some embodiments, the number of the elastic strips in the body portion is plural, all the elastic strips spirally extend in a same direction with the axis of the connecting rod as a rotation center line, and the elastic member is cylindrical or conical.

In some embodiments, the body portion further has a second ring portion, one end of the elastic strip is joined to the first ring portion, the other end of the elastic strip is joined to the second ring portion, and the body portion is connected with one of the actuator, the connecting rod, the matching member, and the container cap through the second ring portion.

In some embodiments, the first ring portion and the second ring portion are provided up and down in an axial direction of the connecting rod, and outer diameters of the first ring portion and the second ring portion are the same, or, the outer diameter of the lower one of the first ring portion and the second ring portion is greater than the outer diameter of the upper one of the first ring portion and the second ring portion.

In some embodiments, the elastic member and the one of the actuator, the connecting rod, the matching member, and the container cap provided integrally with the elastic member are integrally formed of a same plastic material.

In some embodiments, the actuator and the container cap are matched with each other to form a mounting cavity, and the elastic member sleeves the connecting rod and is always located in the mounting cavity.

In some embodiments, the elastic member and the connecting rod are provided integrally, the first ring portion sleeves the connecting rod, and the body portion is located above the first ring portion. Further, the elastic member further includes the above-mentioned second ring portion, the second ring portion is integrally formed at an upper portion of the connecting rod, and an outer diameter of the second ring portion is larger than a rod diameter of the connecting rod.

In some embodiments, the elastic member and the actuator provided integrally, the first ring portion sleeves the connecting rod, and the body portion is located above the first ring portion and located at a lower end portion of the actuator.

In some embodiments, the elastic member and the matching member are provided integrally, the first ring portion sleeves the connecting rod and axially abuts against the upper portion of the connecting rod or the actuator, and the body portion is located below the first ring portion.

In some embodiments, the elastic member and the container cap are provided integrally, the first ring portion sleeves the connecting rod and axially abuts against the upper portion of the connecting rod or the actuator, and the body portion is located below the first ring portion.

Due to the use of the above technical solutions, compared with the prior art, the disclosure has the following advantages: in the all-plastic lotion pump according to the disclosure, the elastic member and the container cap or the connecting rod or the actuator or the matching member in the pump core assembly are integrally provided, and can be integrally formed by using the same plastic material, so that the number of components in the lotion pump is decreased, the number of molds is reduced, the production cost is reduced, and mounting is more convenient; the lotion pump can be integrally recycled after being used, thereby avoiding environmental pollution and waste of resources.

### BRIEF DESCRIPTION OF THE DRAWINGS

FIG. 1 is a schematic front diagram of a lotion pump according to a first embodiment of the disclosure;

FIG. 2 is a schematic side diagram of the lotion pump according to the first embodiment;

FIG. 3 is a schematic sectional structural diagram along A-A in FIG. 2;

FIG. 4 is a schematic top and side perspective diagram of an overall structure of a connecting rod and an elastic member in the lotion pump according to the first embodiment;

FIG. 5 is a schematic side perspective diagram of an overall structure of a connecting rod and an elastic member in the lotion pump according to the first embodiment;

FIG. 6 is another schematic side perspective diagram of an overall structure of a connecting rod and an elastic member in the lotion pump according to the first embodiment;

FIG. 7 is a schematic side diagram of a lotion pump according to a second embodiment;

FIG. 8 is a schematic sectional structural diagram along B-B in FIG. 7;

FIG. 9 is a schematic side perspective diagram of an overall structure of a connecting rod and an elastic member in the lotion pump according to the second embodiment;

FIG. 10 is a schematic top and side perspective diagram of an overall structure of a connecting rod and an elastic member in the lotion pump according to the second embodiment;

FIG. 11 is a schematic bottom and side perspective diagram of an overall structure of a connecting rod and an elastic member in the lotion pump according to the second embodiment;

FIG. 12 is a schematic side diagram of a lotion pump according to a third embodiment;

FIG. 13 is a schematic sectional structural diagram along C-C in FIG. 12;

FIG. 14 is a schematic top and side perspective diagram of an overall structure of an actuator and an elastic member in the lotion pump according to the third embodiment;

FIG. 15 is a schematic side perspective diagram of an overall structure of an actuator and an elastic member in the lotion pump according to the third embodiment;

FIG. 16 is a schematic bottom and side perspective diagram an overall structure of an actuator and an elastic member in the lotion pump according to the third embodiment;

FIG. 17 is another schematic side diagram of an overall structure of an actuator and an elastic member in the lotion pump according to the third embodiment;

FIG. 18 is a schematic side diagram of a lotion pump according to a fourth embodiment;

FIG. 19 is a schematic sectional structural diagram along C-C in FIG. 12;

FIG. 20 is a schematic top and side perspective diagram of a matching member and an elastic member in the lotion pump according to the fourth embodiment;

FIG. 21 is a schematic side perspective diagram of a matching member and an elastic member in the lotion pump according to the fourth embodiment;

FIG. 22 is another schematic side perspective diagram of an overall structure of a matching member and an elastic member in the lotion pump according to the fourth embodiment;

FIG. 23 is a schematic side diagram of a lotion pump according to a fifth embodiment;

FIG. 24 is a schematic sectional structural diagram along D-D in FIG. 23; and

FIG. 25 is a schematic side perspective diagram of a matching member and an elastic member in the lotion pump according to the fifth embodiment;

FIG. 26 is a schematic perspective diagram of a matching member and an elastic member in the lotion pump according to the fifth embodiment;

FIG. 27 is another schematic side perspective diagrams of an overall structure of a matching member and an elastic member in the lotion pump according to the fifth embodiment.

In the drawings: 1. container cap; 2. connecting rod; 3. actuator; 4. matching member (lock cover);
5. elastic member; 51. first ring portion; 52. elastic strip; 53. second ring portion; 54. body portion; 6. pump body.

### DETAILED DESCRIPTION

The technical solution of the disclosure is further explained below with reference to the drawings and the specific embodiments.

### First Embodiment

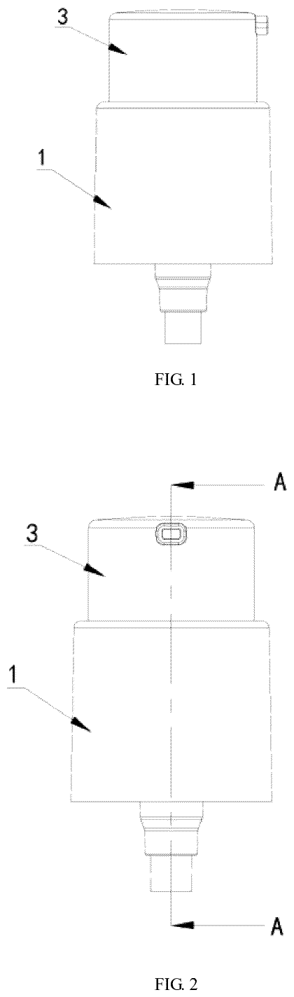

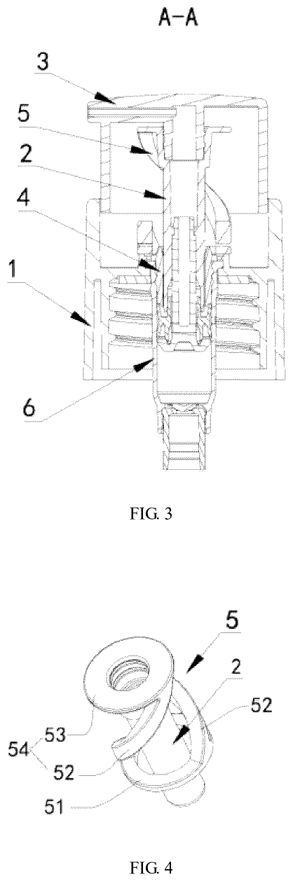

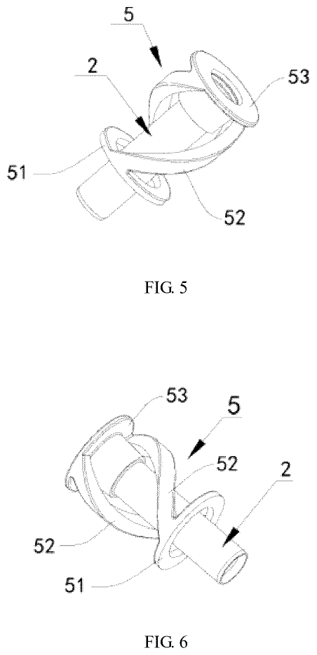

Referring to FIG. 1 to FIG. 6, an all-plastic lotion pump includes a container cap 1 and a pump core assembly provided on the container cap 1, wherein the pump core assembly at least includes a connecting rod 2 capable of moving up and down relative to an axial direction of the container cap 1, an actuator 3 fixedly provided at a top of the connecting rod 2, a pump body 6 fixedly provided on the container cap 1 in a matching manner, and a matching member 4 fixedly provided on the pump body 6 in a matching manner, the matching member 4 is specifically a lock cover, and the matching member 4 is configured to position and fixedly mount the pump core assembly in the axial direction of the container cap 1. The lotion pump further includes an elastic member 5 for providing an action force required for the connecting rod 2 and the actuator 3 to move upwards to be away from the container cap 1, so that after the actuator 3 is pressed to drive the connecting rod 2 to move downwards to pump lotion out, the actuator 3 and the connecting rod 2 can be reset upwards under the action of an elastic force of the elastic member 5.

Referring to FIG. 1 to FIG. 6, in the present embodiment, the elastic member 5 and the connecting rod 2 are provided integrally, the elastic member 5 at least includes a first ring portion 51 capable of sleeving the periphery of the outer side of the connecting rod 2 in a sliding fit manner, and a body portion 54 capable of elastically stretching in an up-down direction, the body portion 54 includes more than one (here, two) elastic strip 52, all the elastic strips 52 extend spirally with the axis of the connecting rod 2 as a rotation center line, one end portion of the body portion 54 is fixedly connected with the first ring portion 51, and the other end portion of the body portion 54 is connected with the connecting rod 2.

The elastic strip 52 has a height and thickness, and is in a wide-band shape in a fully expanded state. In the present embodiment, the longitudinal section of the elastic strip 52 along the height direction is rectangular, and in other embodiments, the section of the elastic strip 52 may be configured in one of a square shape, a shuttle shape, a diamond shape, an oval shape, an I shape and a U shape, or other non-listed sectional shapes.

In the present embodiment, the body portion 54 further has a second ring portion 53, one end of the elastic strip 52 is joined to the first ring portion 51, the other end of the elastic strip 52 is joined to the second ring portion 53, and the body portion 54 is connected with the connecting rod 2 through the second ring portion 2, so that the body portion 54 and the connecting rod 2 form an integral structure; a center hole of the second ring portion 53 is communicated with an axially through hole in the connecting rod 2.

In the present embodiment, the first ring portion 51 and the second ring portion 53 are provided up and down in the axial direction of the connecting rod 2, outer diameters of the first ring portion 51 and the second ring portion 53 are the same and both larger than an outer diameter of the connecting rod 2, and the elastic member 5 has a cylindrical structure as a whole. Here, the first ring portion 51 is located below the second ring portion 53, and the first ring portion 51 sleeves the periphery of the outer side of the connecting rod 2. During production and manufacturing, the elastic member 5 and the connecting rod 2 can be integrally formed as a unitary component from the same plastic material.

When the lotion pump is assembled, the connecting rod 2 and the elastic member 5 can participate in assembly of all components on the pump core assembly together and are then mounted on the container cap 1 together, the elastic member 5 is always located in a mounting cavity formed by mutually matching the actuator 3 and the container cap 1, and a lower portion of the first ring portion 51 abuts against the container cap 1 or the lock cover 4. When the actuator 3 is pressed downwards, the second ring portion 53 moves downwards synchronously, so that the elastic member 5 is compressively deformed in the up-down direction; when the actuator 3 is released, the second ring portion 53 and the actuator 3 are driven to be reset upwards under the elastic action force of the elastic member 5.

### Second Embodiment

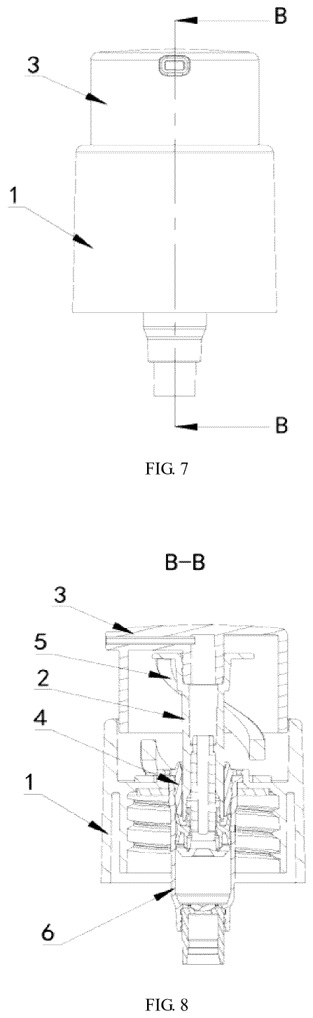

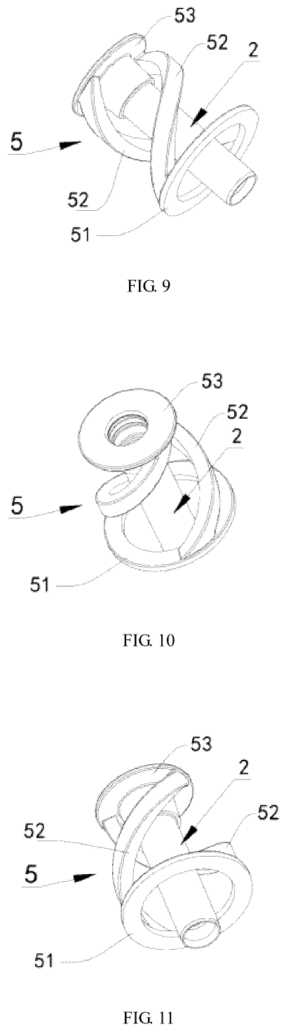

Referring to FIG. 7 to FIG. 11, compared with the lotion pump according to the first embodiment, an all-plastic lotion pump according to this present embodiment has a main difference that the outer diameter of the first ring portion 51 is larger than the outer diameter of the second ring portion 52 on the elastic member 5; that is, the elastic member 5 is conical, in particular, frustum-shaped.

### Third Embodiment

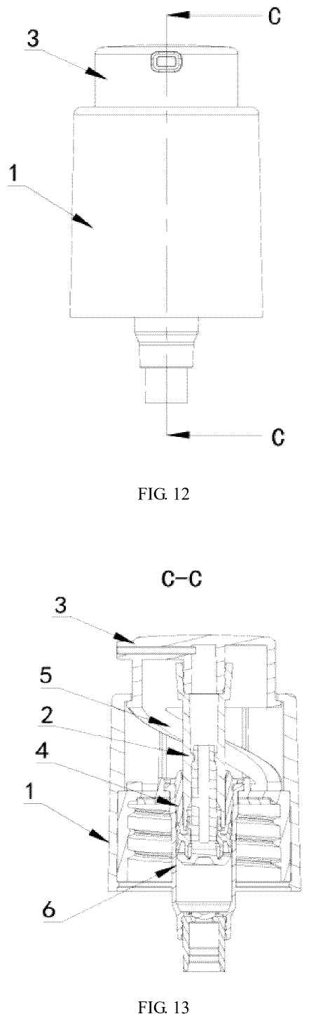

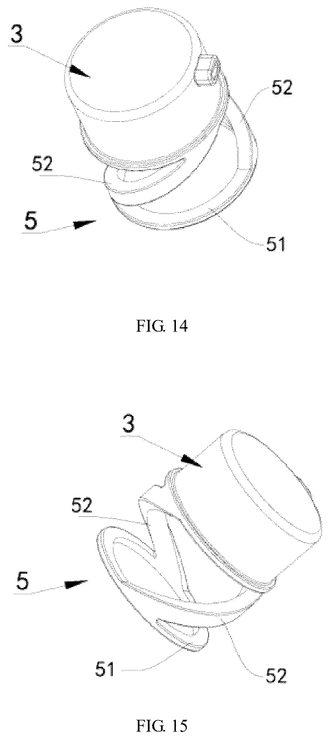

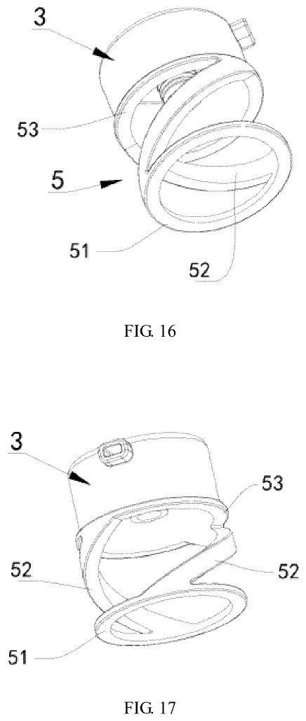

Referring to FIG. 12 to FIG. 17, compared with the lotion pump according to the first embodiment, an all-plastic lotion pump according to this present embodiment has a main difference that the elastic member 5 and the actuator 3 are provided integrally, the elastic member 5 is integrally cylindrical, the body portion 54 is located above the first ring portion 51, and the second ring portion 53 is integrally provided at the bottom of the actuator 3. During mounting, after the components on the pump core assembly except the actuator 3 and the elastic member 5 are all mounted on the container cap 1, the elastic member 5 sleeves the periphery of the outer side of the connecting rod 2, the actuator 3 is fixedly mounted at the top of the connecting rod 2, and then, the assembly of the lotion pump can be completed.

### Fourth Embodiment

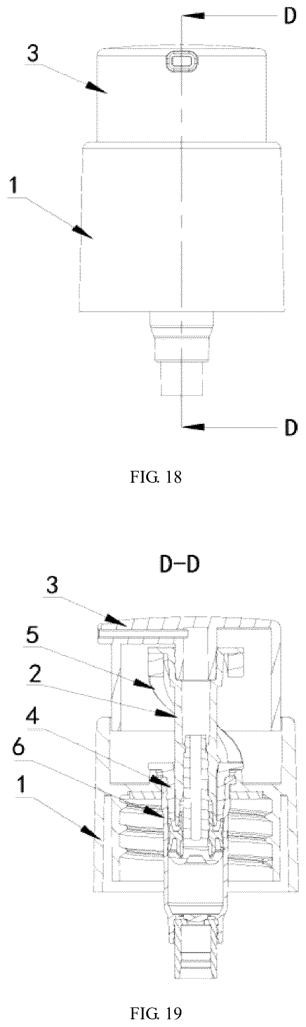

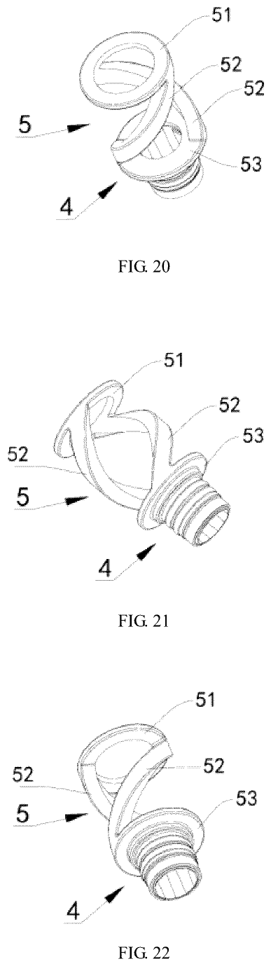

Referring to FIG. 18 to FIG. 22, compared with the lotion pump according to the first embodiment, an all-plastic lotion pump according to this present embodiment has a main difference that the elastic member 5 and the lock cover 4 are provided integrally, the elastic member 5 is integrally cylindrical, the body portion 54 is located below the first ring portion 51, and the second ring portion 53 is integrally provided at the top of the lock cover 4. The second ring portion 53 has an outer diameter larger than that of a body part of the lock cover 4, and the second ring portion 53 is located in the mounting cavity formed by mutually matching the container cap 1 and the actuator 3 and abuts downwards against the pump body 6. The first ring portion 51 sleeves the connecting rod 2 and axially abuts against an upper portion of the connecting rod 2 or the actuator 3, and here, the first ring portion 51 specifically abuts against a flange of the upper portion of the connecting rod 2 upwards. During mounting, in the process of mounting the pump core assembly to the container cap 1, the connecting rod 2 is sleeved with the lock cover 4 with the elastic member 5 in advance, and then, the lock cover 4 is engaged and mounted to the pump body 6.

### Fifth Embodiment

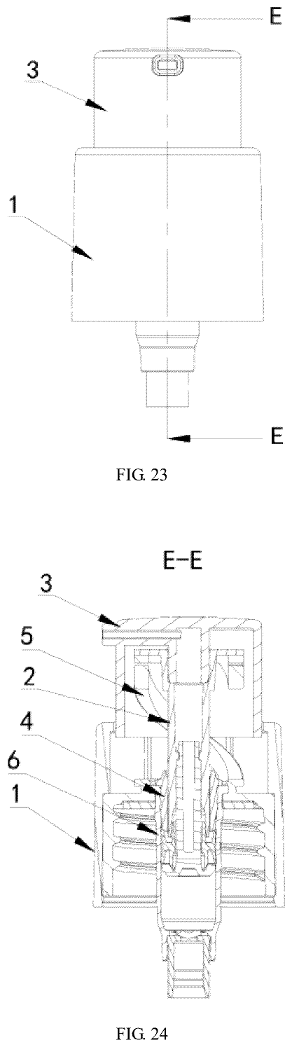

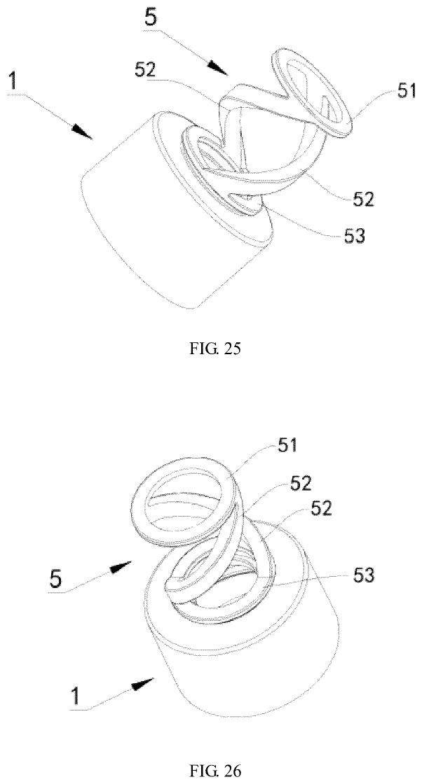

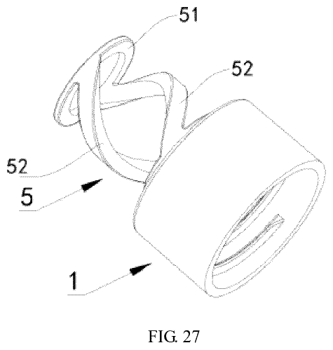

Referring to FIG. 23 to FIG. 27, compared with the lotion pump according to the first embodiment, an all-plastic lotion pump according to this present embodiment has a main difference that the elastic member 5 and the container cap 1 are provided integrally. Here, the elastic member 5 is integrally cylindrical, the body portion 54 is located below the first ring portion 51, and the second ring portion 53 is integrally provided at a top of the container cap 1. The second ring portion 53 has an outer diameter smaller than that of a body part of the container cap 1, and the second ring portion 53 is located in the mounting cavity formed by mutually matching the container cap 1 and the actuator 3. The first ring portion 51 sleeves the connecting rod 2 and axially abuts against the upper portion of the connecting rod 2 or the actuator 3, and here, the first ring portion 51 specifically abuts against a flange of the upper portion of the connecting rod 2 upwards. During mounting, the pump core assembly is assembled on the container cap 1 in a conventional manner, and the connecting rod 2 is inserted into the elastic member 5 in the assembling process.

In conclusion, in the all-plastic lotion pump according to the disclosure, the elastic member 5 and the container cap 1 or the connecting rod 2 or the actuator 3 or the lock cover 4 as the matching member in the pump core assembly are integrally provided, and can be integrally formed by using the same plastic material, so that the number of the components in the lotion pump is decreased, one mold is saved, the production cost is reduced, and mounting is more convenient; the lotion pump can be integrally recycled after being used, thereby avoiding environmental pollution and waste of resources.

The above-mentioned embodiments are merely illustrative of the technical concepts and features of the disclosure, and are intended to enable those skilled in the art to understand the contents of the disclosure and implement the disclosure, and not to limit the protection scope of the disclosure. All equivalent changes and modifications made according to the essence of the disclosure should be covered in the protection scope of the disclosure.

1. An all-plastic lotion pump, comprising a container cap and a pump core assembly provided on the container cap, wherein the pump core assembly at least comprises a connecting rod capable of moving up and down relative to an axial direction of the container cap, an actuator fixedly provided at a top of the connecting rod, a pump body fixedly provided on the container cap in a matching manner, and a matching member fixedly provided on the pump body in a matching manner, the lotion pump further comprises an elastic member for providing an action force required for the connecting rod and the actuator to move upwards to be away from the container cap, the elastic member and one of the actuator, the connecting rod, the matching member, and the container cap are integrally provided, the elastic member at least comprises a first ring portion and a body portion capable of elastically stretching in an up-down direction, the first ring portion is capable of sleeving a periphery of an outer side of the connecting rod in a sliding fit manner, the body portion comprises more than one elastic strip, all the elastic strips extend spirally with an axis of the connecting rod as a rotation center line, one end portion of the body portion is fixedly connected with the first ring portion, and the other end portion of the body portion is connected with one of the actuator, the connecting rod, the matching member, and the container cap.

2. The all-plastic lotion pump according to claim 1, wherein the number of the elastic strips in the body portion is plural, and all the elastic strips spirally extend in a same direction with the axis of the connecting rod as a rotation center line.

3. The all-plastic lotion pump according to claim 1, wherein the body portion further has a second ring portion, one end of the elastic strip is joined to the first ring portion, the other end of the elastic strip is joined to the second ring portion, and the body portion is connected with one of the actuator, the connecting rod, the matching member, and the container cap through the second ring portion.

4. The all-plastic lotion pump according to claim 3, wherein the first ring portion and the second ring portion are provided up and down in an axial direction of the connecting rod, and outer diameters of the first ring portion and the second ring portion are the same, or, the outer diameter of the lower one of the first ring portion and the second ring portion is greater than the outer diameter of the upper one of the first ring portion and the second ring portion.

5. The all-plastic lotion pump according to claim 3, wherein the second ring portion is integrally formed at an upper portion of the connecting rod, and an outer diameter of the second ring portion is larger than a rod diameter of the connecting rod.

6. The all-plastic lotion pump according to claim 1, wherein the elastic member is cylindrical or conical.

7. The all-plastic lotion pump according to claim 1, wherein the elastic member and the one of the actuator, the connecting rod, the matching member, and the container cap provided integrally with the elastic member are integrally formed of a same plastic material.

8. The all-plastic lotion pump according to claim 1, wherein the actuator and the container cap are matched with each other to form a mounting cavity, and the elastic member sleeves the connecting rod and is always located in the mounting cavity.

9. The all-plastic lotion pump according to claim 1, wherein the elastic member and the connecting rod are provided integrally, the first ring portion sleeves the connecting rod, and the body portion is located above the first ring portion.

10. The all-plastic lotion pump according to claim 1, wherein the elastic member and the actuator provided integrally, the first ring portion sleeves the connecting rod, and the body portion is located above the first ring portion and located at a lower end portion of the actuator.

11. The all-plastic lotion pump according to claim 1, wherein the elastic member and the matching member are provided integrally, the first ring portion sleeves the connecting rod and axially abuts against an upper portion of the connecting rod or the actuator, and the body portion is located below the first ring portion.

12. The all-plastic lotion pump according to claim 1, wherein the elastic member and the container cap are provided integrally, the first ring portion sleeves the connecting rod and axially abuts against an upper portion of the connecting rod or the actuator, and the body portion is located below the first ring portion.
